(19) United States
(12) Patent Application Publication
(10) Pub. No.: US 2020/0201284 A1
(43) Pub. Date: Jun. 25, 2020

(54) METHOD AND SYSTEM FOR AUTOMATIC GENERATION OF COMPUTER-AIDED MANUFACTURING INSTRUCTIONS

(71) Applicant: Autodesk, Inc., San Rafael, CA (US)

(72) Inventors: Luke Edwards, Birmingham (GB); Nathan David Rogers, Rugeley (GB)

(21) Appl. No.: 16/229,917

(22) Filed: Dec. 21, 2018

(51) Int. Cl. G05B 19/4097; G05B 19/4093; G05B 19/18

(52) U.S. Cl. CPC G05B 19/4097; G05B 19/4093; G05B 2219/34202; G05B 2219/35167; G05B 2219/32129; G05B 19/182

(57) ABSTRACT

Methods, systems, and apparatus, including medium-encoded computer program products, for creating toolpaths for parts in Computer-Aided Manufacturing (CAM) include a method including: storing information regarding toolpaths used previously to manufacture parts using CAM systems and techniques, selecting stored toolpaths for use with a new part based on similarity of one or more features of the new part to one or more features of one or more previous parts, and using the selected toolpath(s) as a starting point for use in generating a new toolpath for the new part.

### BACKGROUND

This specification relates Computer-Aided Manufacturing (CAM). In general, CAM includes the use of software to control machine tools and related devices in the manufacturing of parts. Traditional CAM includes the Computer Numerical Control (CNC) of machine tools in order to manufacture a part from a two-dimensional (2D) or three-dimensional (3D) model using subtractive manufacturing, where portions of stock material are cut away with milling tools to form the final part. In addition, existing parts manufacturing systems and techniques include additive manufacturing, also known as solid free form fabrication or 3D printing, which refers to any manufacturing process where 3D parts are built up from raw material (generally powders, liquids, suspensions, or molten solids) in a series of two-dimensional layers or cross-sections.

### SUMMARY

This specification describes systems and methods relating to creating toolpaths for parts in Computer-Aided Manufacturing (CAM). As used herein, CAM refers to subtractive manufacturing, additive manufacturing, or combinations thereof, and a CAM program can include a Computer-Aided Drafting (CAD) program, a Computer Aided Engineering (CAE) program, or combinations thereof In general, CAD information for a part and toolpaths to manufacture the part are stored in a long-term datastore. The system may then find similar parts or similar features on the previous parts that already have toolpaths created for them. The toolpaths for the previous part may then be applied to the target part as the starting point for a generative engine. The generative engine can vary the value of machining parameters (e.g., tool type, step over, step down) in order to change the machined result.

The generative engine can assess this result against a number of criteria (e.g., surface finish, manufacturing time, machine acceleration and jerk, tooling changes, etc.) and iterate to find either a best solution or a number of best solutions. This can then give a CAM engineer a start point that is much further along in the process than starting anew for each part. The user would then be able to apply their own modifications to the toolpaths. This updated toolpath can then be submitted back to the long-term datastore for future learning of the system and benefit future parts passed into the engine.

In general, one or more aspects of the subject matter described in this specification can be embodied in a method for generation of computer-readable instructions usable to operate at least one computer-controlled manufacturing machine, the method including: maintaining a library of first data, the first data including (i) historical-toolpaths of one or more computer-controlled manufacturing machines used in parts manufacturing, (ii) information about historical-features of parts that have been manufactured in the parts manufacturing, and (iii) for each historical-feature in the first data, associated information that associates the historical-feature with one or more of the historical-toolpaths with which the historical-feature is manufacturable; receiving, for a new part to be manufactured with at least one of the one or more computer-controlled manufacturing machines, second data that includes information about new features of the new part, wherein at least one of the new features has a difference from any of the historical-features in at least one parameter; selecting historical-toolpaths from the first data by searching for historical-features in the first data having a similarity to at least one of the new features of the new part; assembling a provisional set of toolpaths from the selected historical-toolpaths; and generating a final set of toolpaths that include at least one new-toolpath by refining at least one of the historical-toolpaths in the provisional set of toolpaths using the difference of the new feature.

The method can include: manufacturing, using at least one of the one or more computer-controlled manufacturing machines, the new part using the final set of toolpaths. The library can be built from historical toolpaths that have been used historically by a particular manufacturing entity; and the method includes: manufacturing, using the historical toolpaths, historical parts using the one or more computer-controlled manufacturing machines. The library can be updated to reflect a change in available machines to the particular manufacturing entity. The library can be updated to include (i) the at least one new-toolpath, (ii) the new feature, and (iii) associating information that associates the new feature with the at least one new-toolpath.

The information about new features of the new part in the second data can be organized into a hierarchical tree. Each of the toolpaths can include one or more toolpath-parameters that define features of actions to be taken by one of the one or more computer-controlled manufacturing machines in the manufacture of parts; and refining at least one of the historical-toolpaths in the provisional set of toolpaths can include changing a toolpath-parameter of a historical-toolpath using the difference to generate a refined-parameter. Refining at least one of the historical-toolpaths in the provisional set of toolpaths can include, iteratively changing a toolpath-parameter of a historical-toolpath using the difference to generate a refined-parameter and simulating manufacturing using the refined-parameter until a result of the simulated manufacturing produces a result within a threshold of a desired criteria.

Assembling the provisional set of toolpaths can include: identifying, as an unmatched-feature, a new feature for which no matching historical-feature is matched; generating an unmatched-toolpath for the unmatched-feature; and including the unmatched-toolpath in the final set of toolpaths. The library can be updated to include (i) the unmatched-toolpath, (ii) the unmatched-feature, and (iii) associating information that associates the unmatched-feature with the unmatched-toolpath. Moreover, the various systems and techniques of the method can be used in various combinations.

Further, one or more aspects of the subject matter described in this specification can be embodied in a non-transitory computer-readable medium having instructions that, when executed by a processor, cause the processor to perform operations of any of the disclosed methods, including in the various combinations thereof. In addition, one or more aspects of the subject matter described in this specification can be embodied in a system for generation of computer-readable instructions usable to operate at least one computer-controlled manufacturing machine, the system including: a computer including memory and a processing device, the computer being configured to perform operations of any of the disclosed methods, including in the various combinations thereof. Moreover, the system can include the computer-controlled manufacturing machine being configured to: manufacture the new part using the final set of toolpaths.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system for storing and generating toolpaths.

FIG. 2 shows an example of a system for using CAM processes to generate instructions for a CNC machine.

FIG. 3 shows a swimlane diagram of an example process for building a library of historical-toolpaths for parts.

FIG. 4 shows a swimlane diagram of an example processes used in CAM.

Like reference numbers and designations in the various drawings indicate like elements.

### DETAILED DESCRIPTION

A generative CAM system can use historical toolpaths as an initial starting point when generating toolpaths for a new part to be manufactured. For example, a machine shop may keep a library of toolpaths used successfully on their manufacturing equipment. These toolpaths may be stored in the database with information about the features that were machined with the toolpaths.

When a design for a new part comes into the shop, toolpaths for the new part can be created from these historical toolpaths in the library. For example, features of the new part may be identified and matched to those stored in the library. Then, associated toolpaths in the library may be collected and assembled as a provisional set of toolpaths for the new part. Final toolpaths can be set by altering parameters of the provisional toolpaths to fit the requirements of the new part.

In this way, the CAM process can work from a set of toolpaths known to work well for the given machine shop on the equipment available to the machine shop. This advantageously advances the technology of manufacturing and CAM. Reliability can be increased, as untested and possibly fault-causing toolpaths can be avoided. Speed of manufacture can be increased, as users can become familiar with common toolpaths and can select toolpaths that are not only correct for a given application but also particularly fast, reliable, etc. Further, the time needed to determine an initial toolpath (and hence, e.g., the time needed to define a first cut) can be reduced, and toolpath strategies and best practices can be automatically shared among users of a CAM system.

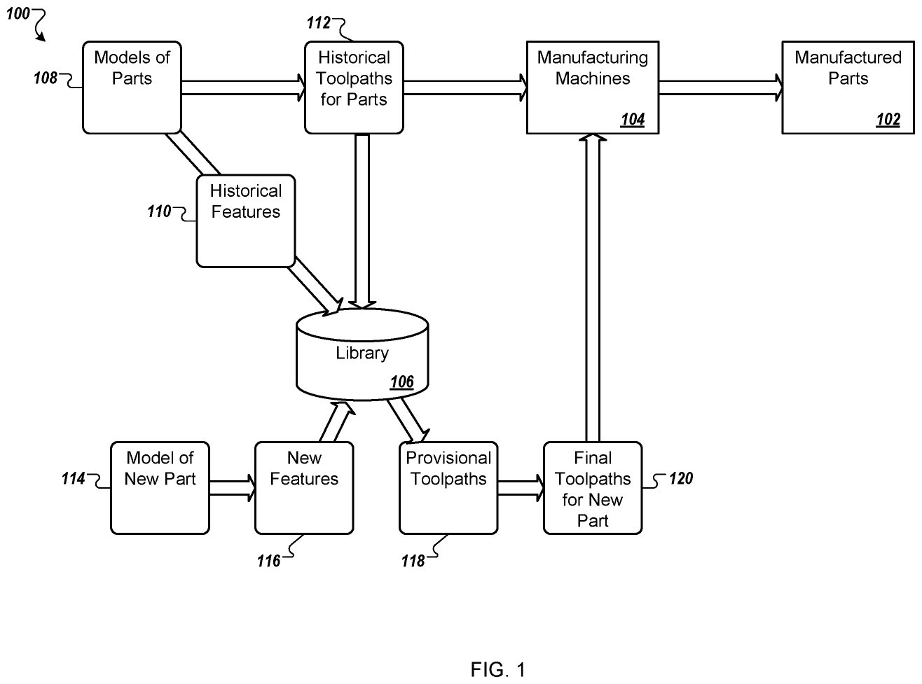

FIG. 1 shows an example of a system 100 for storing and generating toolpaths. The system 100 can be used, for example, to perform CAM processes to manufacture parts 102 in one or more manufacturing machines 104 that use computer-readable instructions to operate (e.g., G code).

A library 106 can be used to store data for the system 100. For example, the library 106 may include a database or other system accessible by users through one or more applications to store data, including toolpaths 112, used in the manufacture of the manufactured parts 102. The library 106 may, for example, receive queries written in structured languages and respond with data in the library 106 that matches the queries.

One type of data stored in the library 106 can include information from models of parts 108. The models of parts 108 can include data that specifies properties of a part 102 that are used in the manufacture of the parts 102. These properties that are specified may include, size, shape, material, and surface finish required for the part 102. For example, technical drawings such as 2D or 3D drawings may be included in the models of the parts 108. These technical drawings may be in the form of one or more files that conform to known or private file formats. Examples of known formats include, but are not limited to, .ipt files, Initial Graphics Exchange Specification (IGES) files, .sat files, Standard for the Exchange of Product Data (STEP) files, etc.

The models 108 can include a collection of features 110 to be manufactured in the part 102. These features can include, for example, surface contours, through-holes, chamfers, threading, etc. In some cases, the features 110 can be organized into hierarchies, with some features being made of one or more other features. For example, a particular surface may be made of a flat surface and an adjacent curved surface to create a beveled face of the part 102. The curved surface may itself be made of many small, flat surfaces that, when combined, approximate a curved surface, etc.

In order to instruct the manufacturing machines 104 to manufacture the parts 102 from the models 108, toolpaths 112 for the models 108 are used. These toolpaths 112 define actions to be taken by the manufacturing machines 104 in order to turn raw stock into the parts 102. For example, for a manufacturing machine 104 that is a milling machine, the toolpaths 112 can include instructions to move in XYZ coordinate space, instructions to rotate the spindle at a particular speed, instructions to change the tool in the spindle, etc. For a powder-bed fusion printer, a type of additive manufacturing machine 104, the toolpaths 112 can include instructions to move in the XY coordinate space for various layers, instructions to extrude a binder, etc.

The toolpaths 112 can be stored in one or more appropriate computer-readable formats. For example, the toolpaths 112 may be stored directly in a format that is usable by the manufacturing machines 104. The milling machine discussed may use an instruction set called, G code, for the movement, rotation, and tool changing discussed. In some cases, the historical toolpaths 112 may be stored in an intermediate format that is then translated (sometimes called ‘post-processing of toolpaths’) into instructions for the manufacturing machines 104. For example, the toolpaths 112 can be toolpath entities that the user can modify and fine tune before post processing to G code to run on a manufacturing machine 104. In any case, these toolpaths may be in the form of one or more files that conform to known or private file formats. Examples of known formats include, but are not limited to, CAM360 files and ART files.

Some or all of this data, the models 108, the toolpaths 112, and the features 110 can be stored in the library 106. For clarity, models 108, features 110, and toolpaths 112 that have been used to manufacture parts 102 or otherwise settled as useful parts, features, and toolpaths are referred to as historical; historical-parts, historical-features, and historical-toolpaths. By way of comparison, a new order to manufacture a part is referred to as new; a model 114 of a new-part will have new-features 116.

The library 106 can maintain associations between historical-toolpaths 112 and historical-features 110 from which they are made. That is, the library 106 may store a feature 110 (e.g., a through-hole) and a toolpath 112 (e.g., a drilling operation with a particular bit) that has been used successfully on the manufacturing machines 104 in the manufacture of a part 102 having the feature 110. Note that a “feature” can be identified with predefined metadata, but the system 100 is designed to handle features that have no predefined label or tag, but rather are identified by the geometry of the part, or the geometry of a portion of the part, as specified in the corresponding model 108. Thus, the toolpath for a piece of part geometry can be treated as metadata that is associated with that part geometry in the library 106. As such, the library 106 may be able to receive a query specifying the feature 110, or a feature like feature 110 (e.g., determined by decomposing the geometry of the new part 114 into sub-geometries), and return the corresponding toolpath 112. This association may be in a form that is dependent on the structure of the library 106. For example, a relational database in the library 106 may include a table “Features” to store the features 110, a table “Toolpaths” to store the toolpaths 112, and a “Historical-Associations” table to store records listing a row in the Features table and a row in the Toolpaths table.

A model 114 of a new part includes new features 116. For example, the machine shop may get a new order to manufacture a part that the machine shop has never manufactured before. This model 114 can include one or more features 116, similar to how the models 108 can include the features 110 for historical models and features.

In order to manufacture the new part using the manufacturing machines 104 (i.e., the same or similar manufacturing machines 104 used to make the historical parts 102), provisional toolpaths 118 can be created from data in the library 106. For example, the new features 116 may be used to search for historical features 110 in the library 106. When a similar or identical historical feature 110 is found, associated historical toolpaths 112 can be accessed and added to a group of provisional toolpaths 118. As such, the library 106 can be used to generate a group of toolpaths, the provisional toolpaths 118, that have been shown to be useful for manufacturing similar features by this machine shop in the manufacturing machines available to the machine shop.

In some implementations, the system 100 includes a scoring system for historical toolpaths 112 associated with historical features 110. For example, when a historical part is manufactured, various data can be collected to assess the performance of the historical toolpath. Such data can be collected automatically as part of the manufacturing process, from the user in response to a query, or both. This data can be stored in the library 106 in association with the corresponding historical toolpath 112 and historical feature 110, and this data can include data regarding various types of success criteria for the manufacture of the part, such as surface finish, manufacturing time, machine acceleration, jerk, cycle time, accuracy of the manufactured geometries, etc. This success criteria information can then be used by the system 100 to score the matches found in the library 106 for new features 116, which assists in finding an optimal (or best available) toolpath starting point when two or more matches are found in the library 106.

In many cases, exact matches between the new features 116 and the historical features 110 are not made. That is, a new feature 116 may be a through-hole of four millimeters through a particular material that is ten millimeters thick. It may be the case that no historical feature 110 is found that is exactly the same (four millimeter hole through the same material that is ten millimeters thick). However, a historical feature 110 that is similar (four millimeter hole through a similar material that is nine millimeters thick) may be identified, and the associated historical toolpath 112 may be added to the provisional toolpaths 118.

In order to find the historical feature 110 that is sufficiently similar to the new feature 116, one or more similarity tests may be used by the library 106. A similarity test may look for historical features 110 that are of the same general type as the new feature 116 and have parameters that are the least different (e.g., numerical differences that are small). For example, one or more portions of the geometry of the model 114 of the new part are compared against one or more portions of geometry of the model 108 of a previously manufactured part (using geometric feature recognition techniques) to identify similar feature(s). Moreover, in some cases, the similarity test can take account of other details that are known about the parts to be manufactured, such as the type(s) of material to be used in the manufacturing of the part (e.g., the materials are the same or are in the same class with examples classes including stainless steel or aluminum) and the type(s) of tools to be used in the manufacturing of the part.

In addition, the similarity test can take account of a feature's placement within a larger context for the part, in that a new feature is more similar to an historical feature when both features are located near to, overlap with, and/or are sub-parts of other features that are also similar. Thus, the similarity test for a given feature can take into account a group of features that includes the given feature. In some implementations, each part is decomposed into a feature tree, and the similarity measure compares the entire feature tree of a new part against the entire feature tree of an historical part to identify similarities within the feature trees, and thus specific features within new part's feature tree that are similar enough to historical features that the historical toolpaths may provide a good starting point for generating a new toolpath. The feature tree can be a prismatic feature tree, but need not be limited to such. In some implementations, the features (e.g., in a feature tree for a part) include both prismatic features (where each feature is formed from one or more regular geometric shapes) and free form (sculpted) features, e.g., defined using NURB (nonuniform rational B-spline) surfaces in a CAD model.

The similarity test returns a set of provisional toolpaths 118. In some implementations, the scoring system is used to rank the returned provisional toolpaths 118, which assists in selecting a best starting point for a new toolpath. In some implementations, the system 100 automatically identifies a best available match, in which case, the set of provisional toolpaths 118 can be a single toolpath 118. In some implementations, multiple toolpaths 118 are presented to a user with an indication of the quality of each match, as determined by the scoring system, and the user is enabled to select one or more of the returned toolpaths 118 to assemble the provisional set of toolpaths 118.

With the provisional toolpath(s) 118 assembled, final toolpath(s) 120 are created. These final toolpath(s) 120 can include new toolpath(s) created by refining the provisional toolpath(s). In the example of the four millimeter hole new feature 116 above, the provisional toolpath for the hole can be adjusted to increase the depth from nine millimeters to the required ten millimeters. Other refinements may be made according to appropriate CAM processes. For example, where the difference is a difference in material type, a spindle speed and/or bit type can be changed in the final toolpath(s) 120.

The final toolpaths 120 can be sent to the manufacturing machines 104, and the manufacturing machines 104 can manufacture new parts 102 in order to fulfill the new order received by the machine shop. In some cases, the final toolpaths 120 and new features 116 may be added to the library 106 as historical toolpaths and historical features for future use. Moreover, in some implementations, success criteria information is collected for the manufacturing of the new parts 102, e.g., as described above, and stored along with the final toolpaths 120 and the new features 116. Thus, the library 106 can be actively updated with new features, which are not previously defined by a programmer for the system 100, and the library 106 can store those new features as associations of part geometries with toolpaths for their manufacture and information regarding the quality of the manufactures resulting from the use of those toolpaths for the given part geometries.

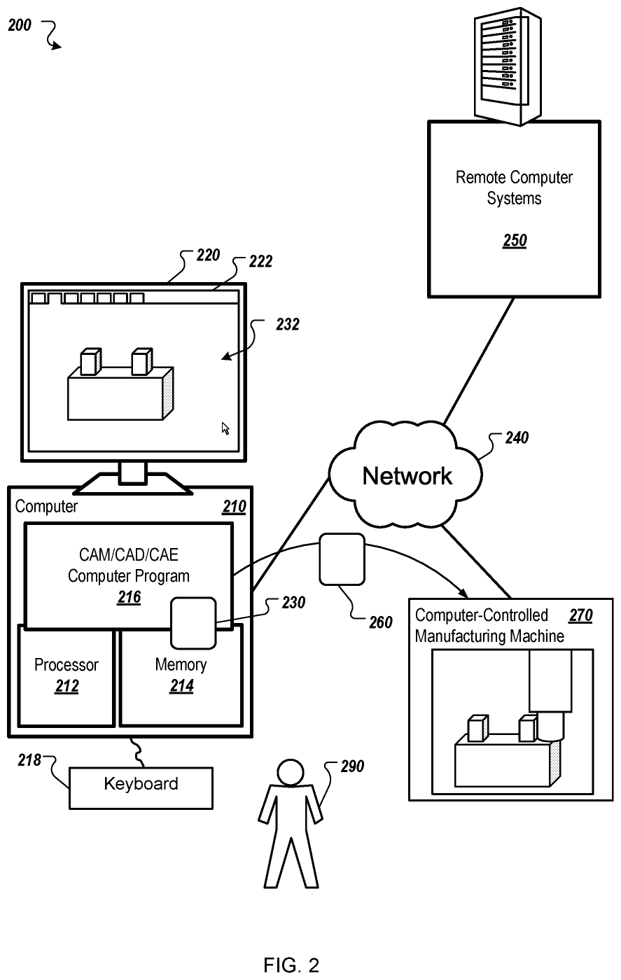

FIG. 2 shows an example of a system 200 for using CAM processes to generate instructions for a CNC machine, for example as described with respect to FIG. 1. A computer 210 includes a processor 212 and a computer-readable medium, such as a memory 214, a storage device, or both, to store instructions of one or more programs 216 (e.g., a CAM program, a CAD program, a CAE program, or a combination thereof) that run on the processor 212. The computer 210 can be connected to a network 240, which can be a private network, a public network, a virtual private network, etc. The processor 212 can be one or more hardware processors, which can each include multiple processor cores. The memory 214 can include both volatile and non-volatile memory, such as Random Access Memory (RAM) and Flash RAM. The computer 210 can include various types of computer storage media and devices, which can include the memory 214.

A computer program 216 can present a user interface (UI) 222 on a display device 220 of the computer 210, which can be operated using one or more input devices 218 of the computer 210 (e.g., keyboard and mouse). Note that while shown as separate devices in FIG. 2, the display device 220 and/or input devices 218 can also be integrated with each other and/or with the computer 210, such as in a tablet computer. In addition, the CNC system 200 includes a computer-controlled manufacturing machine 270, which can include one or more computer-controlled machine tools. The computer-controlled manufacturing machine 270 can include apparatuses that are able to manufacture parts according to a wide variety of mechanisms. For example, the computer-controlled manufacturing machine 270 can include subtractive machines such as milling tools, lathes, grinders, and drill presses. The computer-controlled manufacturing machine 270 can include additive manufacturing machines such as selective-laser-sintering devices, stereolithography printers, and fused filament fabricators. In addition, the computer-controlled manufacturing machine 270 can include other components and systems, such as rotatable platforms/attachments (e.g., for five-axis milling processes), cleaning systems, and/or cooling systems.

The computer-controlled manufacturing machine 270 can include its own computer 210, with processor 212, memory 214, computer program 216, etc. For example, in some implementations, the computer 210 and the computer-controlled manufacturing machine 270 can be integrated together, without a network 240 connecting them. As another example, the computer-controlled manufacturing machine 270 can include a computer that runs a CAM program, which receives as input a model generated by a CAD program 216 and/or a CAE program 216 on a separate computer 210.

In some implementations, the computer-controlled manufacturing machine 270 can simply be the machine tools and other manufacturing components that are controlled by the computer 210, and the program 216 can be a CAM program, which can receive as input a model generated by CAD and/or CAE programs located elsewhere. For example, one or more remote computer systems 250, which are accessible by the computer 210 via the network 240, can include CAD programs and CAE programs used to generate models that are input to and processed by a CAM program 216.

In any case, a CAM system can be provided that allows a user 290 to interact with a model 232 and readily generate a numerical control (NC) program 230 to operate computer-controlled manufacturing machine 270. In the example shown, the model 232 is a 3D model of a particular part to be manufactured, but many different types of models can be used with the system and techniques described herein. Further, in some implementations, the NC program 230 runs on the processor 212 to control the computer-controlled manufacturing machine 270 directly connected thereto. In some implementations, the NC program 230 is output (potentially after conversion to a new program format 260) to the computer-controlled manufacturing machine 270 to run on its local processor.

When generating the NC program 230, the CAM system can be used to assign spindle speed and/or feed rate parameters at each point from hundreds of points that make up a toolpath. Using these assigned parameters, the CAM system can generate NC programs 230, 260 that can gradually speed up and slow down spindle speed and feed rate of the machining tool across a set distance when approaching or leaving one or more predefined portions of the part. Note that determination of the values for the spindle speeds and feed rates can be determined based on material to be used for the part to be manufactured, the tool to be used, and any guidelines provided by the tool manufacturer for acceptable operational parameters for the tool. Testing can also be used determine appropriate speeds to be used with the tool for a given part to be manufactured. Note that components can have certain resonances based on how thick or thin they are, and the tools used in a CNC machine can generate different vibrational frequencies based on the speeds at which they are run when manufacturing a given part. Thus, testing can be used to avoid inappropriate harmonics being generated between the tool and the component. Other manufacturing parameters that can be taken into account include tool engagement, feeds and speeds, bit-type, and depth, method and shape of cut, in the case of subtractive manufacturing. In general, such manufacturing parameters (for subtractive manufacturing and/or additive manufacturing) can be used to inform the toolpath strategies that are developed using the systems and techniques described herein.

In order to generate the NC program 230, the computer 210 can use the CAM program to access (e.g., from the memory 214 or the remote computer systems 250) a library of historical-features and historical-toolpaths that have been used by the system 200 to manufacture historical parts with the computer-controlled manufacturing machine 270, as described herein. This library may be managed and stored by the computer 210, the computer-controlled manufacturing machine 270, and/or the remote systems 250.

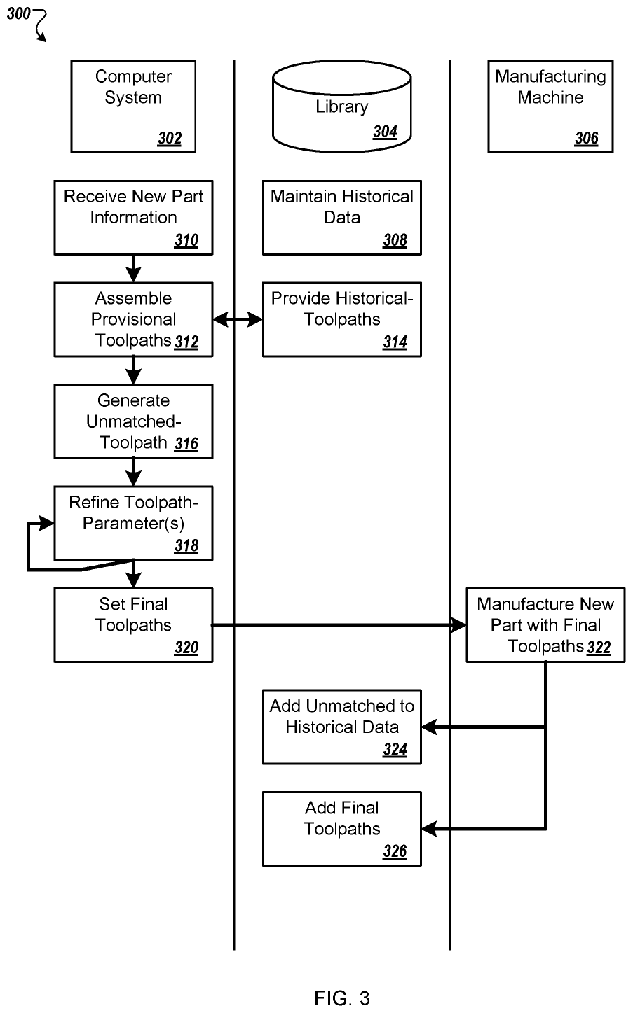

FIG. 3 shows a swimlane diagram of an example process 300 for building a library of historical-toolpaths for parts. In this example, a computer system 302, a library 304, and a manufacturing machine 306 are being used to perform the process 300. The computer system 302 includes one or more computing devices that execute CAM software that generally allows a user to generate toolpaths and/or NC instructions to manufacture parts using the manufacturing machine 306. In some cases, the computer system 302 also manages the library 304 and thus in these cases the library 304 is an element of the computer system 302. In some cases, the library 304 is managed remote from the computer system 302, for example on one or more serves that are sometimes referred to as ‘in the cloud.’

The library 308 maintains historical data 308. For example, the library can record a host of data about historical operations undertaken by a particular manufacturing organization. In one example, a company operates a few geographically separated facilities that have in them manufacturing machines including the manufacturing machine 306. This company receives orders, schedules machine time, and organizes logistics storing data in the library 304.

In some instances, the historical data 308 can include data from other organizations. For example a different organization (e.g., company, non-company organization) may publish data about successful manufacturing events, along with information about what types of manufacturing machines have used this data. Then, the organization operating the system 200 may access this data and add it to the historical data 308. This may be useful, for example, when an academic researcher, an open-source project, or a tutorial-writer creates toolpaths and other data using the same manufacturing machines as used by the system 200. In addition, using such a shared “data lake” can provide a much larger source of historical toolpath examples, which allows one company to benefit from the work of another company in generating toolpaths, without having to share the actual CAD files between the different companies.

In addition, the library 304 is used to store first data. The first data can include historical-toolpaths of one or more computer-controlled manufacturing machines used in parts manufacturing. For example, the library 304 can be used to record some or all historical-toolpaths that are generated in the course of operating the organization. This can include toolpaths used for manufacturing parts as well as scores associated with the quality of those toolpaths as determined by the quality of the manufactured parts.

The information stored by the library 304 can include information about historical-features of parts that have been manufactured in the parts manufacturing. For example, the library 304 can be used to record some or all historical-features that are generated in the course of operating the organization. This can include features for manufactured parts in association with the toolpaths used to manufacture those parts and the quality scores therefor.

Thus, the information stored by the library 304 can include, a historical-feature in the first data, associated information that associates the historical-feature with one or more of the historical-toolpaths with which the historical-feature is manufacturable. This associated information can allow the library 304 to identify a historical-toolpath given a historical-feature or a new-feature. This sort of data retrieval may be used in the process 300 and in other processes.

The computer system 302 receives new part information 310. For example, a designer working with the organization can design a new part to be manufactured. After testing and design review, the design is accepted and the organization begins to prepare the tooling needed to manufacture the part, including the use of the manufacturing machine 306.

For the new part to be manufactured with at least the manufacturing machine 306, second data that includes information about new features of the new part is accessed. This information about new features of the new part may be defined, for example, in technical drawings generated by the designer. At least one of the new features has a difference from any of the historical-features in at least one parameter.

For example, while the library 304 may include historical chamfered features, the new part may have a chamfered surface that has is different from any of the historical chamfered features stored in the library 304. In this example, both the new chamfer feature and the historical chamfer feature can be organized into respective feature trees (e.g., a hierarchical tree of prismatic and/or free form sub-parts). In this case, a flat portion of the feature is surrounded by a chamfer, and thus each feature is represented by a tree having sub-nodes for the flat surface having an XY shape and for a chamfer having rise and run values to define a slope.

The computer system 302 assembles provisional toolpaths 312. For example, the computer system 302 can identify all of the new features of the new part that will require one or more toolpaths to be manufactured by the manufacturing machine 306. The computer system 302 can determine that, for some or all of the new features, there are similar historical-features in the library 304 that have associated historical-toolpaths in the library 304. For these new-features, the computer system can request historical-toolpaths of historical features that are similar to the new-features using the systems and techniques described above. In response, the library 304 provides historical-toolpaths 314.

With these provided historical-toolpaths, the computer system 302 assembles a provisional set of toolpaths by selecting historical-toolpaths from the first data by searching for historical-features in the first data having a similarity to at least one of the new features of the new part and assembling a provisional set of toolpaths from the selected historical-toolpaths. For example, if the library 304 provides more than one possible historical-toolpaths for a given new-feature, the computer system 302 can select one of those historical-toolpaths and add it to the provisional toolpaths for the new-part. As noted above, in some implementations, one or more closest historical-toolpaths can be selected automatically as the set of historical-toolpaths for refining for use with the new part, and in some implementations, a user can be presented with multiple options (e.g., ranked by the scoring system) and then select one or more of the similar historical-toolpaths as the set of historical-toolpaths for refining for use with the new part. In any case, the historical-toolpath 314 that is provided by the library 304 provides a jump start for determining a toolpath for a new part since the parameters associated with the historical toolpath 314 providing a starting point for toolpath strategies (e.g., whether to use 3D offsets, a raster machine, or constant z, etc.) to be used in the new toolpath.

The computer system 302 also generates unmatched-toolpaths 316. For example, some of the new-features of the new-part may not have any matching similar historical-features in the library 304. In such a case, the computer system 302 and/or the library 304 may search the library for one of those new-features but receive a result that no such historical-features are found or that no historical-features are within a particular similarity threshold. In such a case, the computer system 302 can generate an unmatched-toolpath for the unmatched-feature. In some cases, the generation of this unmatched-toolpath can be generated substantially automatically without extensive user input. In some cases, the un-matched feature is flagged for the user so an unmatched-toolpath can be created from scratch, i.e., the generation of the unmatched-toolpath can be generated with substantial user input. For example, the user may specify details such as machining strategy, speeds, feeds, step values, etc. These unmatched-toolpaths can be added to the set of provisional toolpaths by the computer system 302.

The computer system 302 iteratively refines toolpath parameters 318. For example, the computer system 302 can use a difference between the new-feature and a corresponding historical-feature to adjust a parameter of a provisional toolpath. In the example of the chamfered feature, the computer system 302 can determine that the new-feature requires a greater rise value than the chamfer in the historical-feature. In order to provide this greater rise value, the computer system can change one or more parameters such as step-down value and end-mill selection in the historical-toolpath. This process can be completed for all provisional toolpaths in the provisional set.

Then, once completed, this process can be repeated. This kind of iterative repetition allows for refinements that improve accuracy and/or efficiency. For example, one provisional toolpath may be refined in a way that removes material that was expected to be in place by another provisional toolpath. When this process is repeated, the other provisional toolpath can be refined to move quickly past the area where material is removed, increasing efficiency.

Examples of manufacturing parameters that can be varied in an iteration include, but are not limited to, tool type, step over, and step down. By changing these parameters, the expected result of the use of these toolpaths change and can be assessed by the computer system 302. For example, these changes may result in different expected surface finishes, manufacturing time, acceleration and jerk by the manufacturing machine 306. In each iteration, the expected results can be assessed and expected results outside of an acceptable range can be identified. In the next iteration, the parameters of the toolpaths can be adjusted by the computer system 302 to produce modified expected results. This can be repeated until all expected results are within the acceptable ranges.

In this way, a final set of toolpaths are generated that include at least one new-toolpath by refining at least one of the historical-toolpaths in the provisional set of toolpaths based on the difference of the new feature. Each of the toolpaths includes one or more toolpath-parameters that define features of actions to be taken by one of the one or more computer-controlled manufacturing machines in the manufacture of parts. Refining at least one of the historical-toolpaths in the provisional set of toolpaths includes changing a toolpath-parameter of a historical-toolpath based on the difference to generate a refined-parameter. Refining at least one of the historical-toolpaths in the provisional set of toolpaths further includes, iteratively changing a toolpath-parameter of a historical-toolpath based on the difference to generate a refined-parameter and simulating manufacturing using the refined-parameter until a result of the simulated manufacturing produces a result within a threshold of a desired criteria. In some implementations, the computer system 302 simulates the removal of material by each toolpath and assesses what the stock model will then look like for subsequent toolpaths, and the stock model can be compared to the CAD model to assess the quality of surface finish. Other parameters of the machining can also be assessed by the computer system 302 during the simulation(s) to refine the toolpath parameters.

The computer system 302 finalizes a set of toolpaths 320. For example, once an iteration is performed with no refinement to any of the provisional toolpaths, the computer system 302 can determine that the provisional toolpaths are ready to be sent to the manufacturing machine 306 and can flag the provisional toolpaths as final toolpaths. In response, the computer system 302 can send the final toolpaths to the manufacturing machine 306.

The manufacturing machine 306 manufactures the new part with the final set of toolpaths 322. For example, the manufacturing machine 306 can receive a raw billet of material and process the received toolpaths. This includes cutting the new chamfer feature according to the received toolpaths in order to make a part matching the received new part information 310.

The library 304 adds unmatched toolpaths to the historical data 324. For example, in order to maintain operational efficiency, the organization can include the unmatched-features and the unmatched-toolpaths in the library 304 for use in future CAM processes. The library 304 can store associating information that associates the unmatched-feature with the unmatched-toolpath so that the unmatched-toolpath can be found when searching with a new-feature similar to the unmatched-feature. In other words, the unmatched feature can become an historical feature when its toolpath is added to the library 304 along with the feature. Moreover, in some cases, the scoring system assesses the quality of the unmatched toolpath that was created for the unmatched feature (based on results of the manufacturing) before adding it to the library, as a minimum level of quality may be required before a newly created toolpath is accepted into the library 304 as a starting point for future toolpaths to be created.

The library 304 adds final toolpaths to the historical data 326. For example, in order to maintain operational efficiency, the organization can include the new-features and the associated final toolpaths in the library 304 for use in future CAM processes. The library 304 can store associating information that associates the new-feature with its final toolpath so that the final toolpaths can be found when searching with a new-feature similar to this feature. As before, in some implementations, the scoring system assesses the quality of the final toolpath (based on results of the manufacturing) before adding it to the library, as a minimum level of quality may be required before any toolpath is accepted into the library 304 as a starting point for future toolpaths to be created.

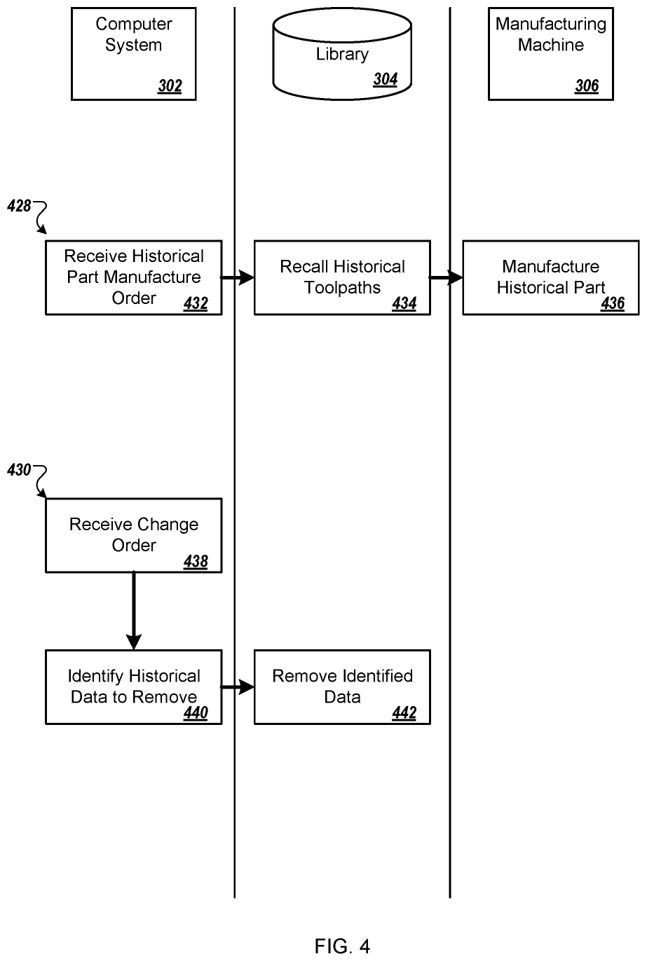

FIG. 4 shows a swimlane diagram of an example of processes 428 and 430 used in CAM. In this example, the process 428 and 430 are being described as being performed by the same organization as that discussed with respect to the process 300. Therefore, the computer system 302, library 304, and manufacture machine 306 are included in the description. However, a different system or systems may be used to perform the process 300, 428, and 430.

In addition to the manufacture of a new part as described in the process 300, the organization may also use the information in the library 304 to manufacture the historical parts. For example, the computer system 302, library 304, and manufacturing machine 306 may be used as part of a full-featured CAM package that offers many features in addition to those described in this document. As part of supporting these features, the library 304 can maintain historic data used for many purposes. One such purpose is the easy repetition of manufacturing historic orders.

The computer system 302 receives an order for a historical part manufacture 432. For example, the computer system 302 may generate or receive a work order to manufacture one lot of a standard part used by the organization (e.g., a bracket used in an assembly that is sold by the organization).

The library 304 recalls the historical toolpaths 434. For example, instead of generating toolpaths and other data anew every time the order for this bracket comes in, the computer system 302 can send a request to the library 304 to recall the historic-toolpaths from memory. Because the library 304 is built, in this example, from historical toolpaths that have been used historically by a particular manufacturing entity, the library 304 is able to quickly and efficiently recall the toolpaths.

The manufacturing machine 306 manufactures the historical part 436. The manufacturing machine 306 is able to manufacture efficiently and reliably because the manufacturing machine is using historic-toolpaths that have been tested and validated to produce the bracket within specifications needed by the organization. Moreover, in some cases, the system may have worked out better ways to machine this part based on other parts made in the interim, and this can be determined when the search of the library 304 returns results along with scoring information.

The organization is also able to keep the information in the library 304 up to date by modifying the information as the services and machines available for manufacture change. For example, if the organization decides to deprecate a particular manufacturing machine and remove it from service, the library 304 can be updated to remove toolpaths for that machine. Similarly, associating data can be updated so that, in the future, when a new part is to be manufactured, toolpaths for the deprecated machine are not accessed. Similarly, if a new machine is introduced into the organization, the library 304 can be seeded with new toolpaths that have been used. For example, while testing the manufacturing machine 306, technicians can generate toolpaths as part of the testing process. Those toolpaths that have produced reliable results may be added to the library 304 along with information associating the toolpaths with their associated features.

The computer system 302 receives a change order 438. For example, the organization may decide to remove a selective-laser-sintering (SLS) additive manufacturing machine 306 from their facilities. As such, an operator of the computer system 302 may submit a change order to the computer system 302 to deprecate the old SLS manufacturing machine 306 and to add toolpaths and information for the new SLS manufacturing machine.

The computer system 302 identifies 440 historical data in the library 304 to remove 442. For example, historical-toolpaths used only by the SLS manufacturing machine 306 can be identified. Then, historic-features that are only associated with those identified-for-removal toolpaths can be identified. The computer system 302 can send a message to the library 304 to remove data related to these identified toolpaths and features.

The library 304 removes the identified data 442. As the library 304 is updated based on a change in available machines to the particular manufacturing entity, the library 304 can maintain up-to-date information that remains usable for other CAM operations, including for example the process 300.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Thus, particular embodiments of the invention have been described. Other embodiments are within the scope of the following claims. In addition, the actions recited in the claims can be performed in a different order and still achieve desirable results.

What is claimed is:

1. A method for generation of computer-readable instructions usable to operate at least one computer-controlled manufacturing machine, the method comprising:
maintaining a library of first data, the first data including (i) historical-toolpaths of one or more computer-controlled manufacturing machines used in parts manufacturing, (ii) information about historical-features of parts that have been manufactured in the parts manufacturing, and (iii) for each historical-feature in the first data, associated information that associates the historical-feature with one or more of the historical-toolpaths with which the historical-feature is manufacturable;
receiving, for a new part to be manufactured with at least one of the one or more computer-controlled manufacturing machines, second data that includes information about new features of the new part, wherein at least one of the new features has a difference from any of the historical-features in at least one parameter;
selecting historical-toolpaths from the first data by searching for historical-features in the first data having a similarity to at least one of the new features of the new part;
assembling a provisional set of toolpaths from the selected historical-toolpaths; and
generating a final set of toolpaths that include at least one new-toolpath by refining at least one of the historical-toolpaths in the provisional set of toolpaths using the difference of the new feature.

2. The method of claim 1, the method comprising:
manufacturing, using at least one of the one or more computer-controlled manufacturing machines, the new part using the final set of toolpaths.

3. The method of claim 1, wherein the library is built from historical toolpaths that have been used historically by a particular manufacturing entity; and the method comprises:
manufacturing, using the historical toolpaths, historical parts using the one or more computer-controlled manufacturing machines.

4. The method of claim 3, wherein the library is updated to reflect a change in available machines to the particular manufacturing entity.

5. The method of claim 3, wherein the library is updated to include (i) the at least one new-toolpath, (ii) the new feature, and (iii) associating information that associates the new feature with the at least one new-toolpath.

6. The method of claim 1, wherein the information about new features of the new part in the second data is organized into a hierarchical tree.

7. The method of claim 1, wherein:
each of the toolpaths includes one or more toolpath-parameters that define features of actions to be taken by one of the one or more computer-controlled manufacturing machines in the manufacture of parts; and
refining at least one of the historical-toolpaths in the provisional set of toolpaths comprises changing a toolpath-parameter of a historical-toolpath using the difference to generate a refined-parameter.

8. The method of claim 7, wherein refining at least one of the historical-toolpaths in the provisional set of toolpaths comprises, iteratively changing a toolpath-parameter of a historical-toolpath using the difference to generate a refined-parameter and simulating manufacturing using the refined-parameter until a result of the simulated manufacturing produces a result within a threshold of a desired criteria.

9. The method of claim 1, wherein assembling the provisional set of toolpaths comprises:
identifying, as an unmatched-feature, a new feature for which no matching historical-feature is matched;
generating an unmatched-toolpath for the unmatched-feature; and
including the unmatched-toolpath in the final set of toolpaths.

10. The method of claim 9, wherein the library is updated to include (i) the unmatched-toolpath, (ii) the unmatched-feature, and (iii) associating information that associates the unmatched-feature with the unmatched-toolpath.

11. A system for generation of computer-readable instructions usable to operate at least one computer-controlled manufacturing machine, the system comprising:
a computer comprising memory and a processing device, the computer configured to perform operations comprising:
maintaining a library of first data, the first data including (i) historical-toolpaths of one or more computer-controlled manufacturing machines used in parts manufacturing, (ii) information about historical-features of parts that have been manufactured in the parts manufacturing, and (iii) for each historical-feature in the first data, associated information that associates the historical-feature with one or more of the historical-toolpaths with which the historical-feature is manufacturable;
receiving, for a new part to be manufactured with at least one of the one or more computer-controlled manufacturing machines, second data that includes information about new features of the new part, wherein at least one of the new features has a difference from any of the historical-features in at least one parameter;
selecting historical-toolpaths from the first data by searching for historical-features in the first data having a similarity to at least one of the new features of the new part;
assembling a provisional set of toolpaths from the selected historical-toolpaths; and
generating a final set of toolpaths that include at least one new-toolpath by refining at least one of the historical-toolpaths in the provisional set of toolpaths using the difference of the new feature; and
the computer-controlled manufacturing machine configured to:
manufacture the new part using the final set of toolpaths.

12. The system of claim 11, wherein the operations comprise:
manufacturing, using at least one of the one or more computer-controlled manufacturing machines, the new part using the final set of toolpaths.

13. The system of claim 11, wherein the library is built from historical toolpaths that have been used historically by a particular manufacturing entity; and the operations comprise:
manufacturing, using the historical toolpaths, historical parts using the one or more computer-controlled manufacturing machines.

14. The system of claim 13, wherein the library is updated to reflect a change in available machines to the particular manufacturing entity.

15. The system of claim 13, wherein the library is updated to include (i) the at least one new-toolpath, (ii) the new feature, and (iii) associating information that associates the new feature with the at least one new-toolpath.

16. The system of claim 11, wherein the information about new features of the new part in the second data is organized into a hierarchical tree.

17. The system of claim 11, wherein:
each of the toolpaths include one or more toolpath-parameters that define features of actions to be taken by one of the one or more computer-controlled manufacturing machines in the manufacture of parts; and
refining at least one of the historical-toolpaths in the provisional set of toolpaths comprises changing a toolpath-parameter of a historical-toolpath using the difference to generate a refined-parameter.

18. The system of claim 11, wherein refining at least one of the historical-toolpaths in the provisional set of toolpaths comprises, iteratively changing a toolpath-parameter of a historical-toolpath using the difference to generate a refined-parameter and simulating manufacturing using the refined-parameter until a result of the simulated manufacturing produces a result within a threshold of a desired criteria.

19. The system of claim 11, wherein assembling the provisional set of toolpaths comprises:
identifying, as an unmatched-feature, a new feature for which no matching historical-feature is matched;
generating an unmatched-toolpath for the unmatched-feature; and
including the unmatched-toolpath in the final set of toolpaths;
wherein the library is updated to include (i) the unmatched-toolpath, (ii) the unmatched-feature, and (iii) associating information that associates the unmatched-feature with the unmatched-toolpath.

20. A non-transitory computer-readable medium having instructions that, when executed by a processor, cause the processor to perform operations comprising:
maintaining a library of first data, the first data including (i) historical-toolpaths of one or more computer-controlled manufacturing machines used in parts manufacturing, (ii) information about historical-features of parts that have been manufactured in the parts manufacturing, and (iii) for each historical-feature in the first data, associated information that associates the historical-feature with one or more of the historical-toolpaths with which the historical-feature is manufacturable;
receiving, for a new part to be manufactured with at least one of the one or more computer-controlled manufacturing machines, second data that includes information about new features of the new part, wherein at least one of the new features has a difference from any of the historical-features in at least one parameter;
selecting historical-toolpaths from the first data by searching for historical-features in the first data having a similarity to at least one of the new features of the new part;
assembling a provisional set of toolpaths from the selected historical-toolpaths; and
generating a final set of toolpaths that include at least one new-toolpath by refining at least one of the historical-toolpaths in the provisional set of toolpaths using the difference of the new feature.
